(19) United States
(12) Patent Application Publication
(10) Pub. No.: US 2011/0179976 A1
(43) Pub. Date: Jul. 28, 2011

(54) Method of Dedusting a Pulverulent Building Material Composition

(76) Inventors: Manfred Huber, Augsburg (DE); Klaus-Dieter Hoetzl, Augsburg (DE)

(21) Appl. No.: 13/057,789

(22) PCT Filed: May 28, 2009
(86) PCT No.: PCT/EP09/56512

§ 371 Date: Mar. 29, 2011

(30) Foreign Application Priority Data
Aug. 14, 2008 (EP) 08162366,2

(51) Int. Cl. C04B 28/04

(52) U.S. Cl. 106/727; 106/728; 106/724

(57) ABSTRACT

The invention relates to a process for dedusting a pulverulent building material composition, preferably a factory dry mortar and in particular tile adhesive, joint filler, filling compound, sealing slurry, repair mortar, levelling mortar, reinforcing adhesive, adhesive for composite thermal insulation systems (CTIS), mineral render, fine filler and screed systems, at least one dedusting agent which is liquid at 20° C. being brought into contact with the pulverulent building material composition at a temperature of >40° C. Preferably this occurs by spraying.

The present invention relates to a process for dedusting a pulverulent building material composition.

In particular dry, pulverulent building material compositions, such as hydraulically setting materials based on cement, pozzuolana or lime and non-hydraulic setting materials based on gypsum and non-hydraulic lime (e.g. tile adhesives, joint fillers, filling compounds, sealing slurries, renders, screeds, etc.), tend to substantial dust formation, particularly during transfer and mixing processes. Numerous attempts were therefore made to reduce or completely suppress the development of dust in such products.

Thus, for example, attempts were made to reduce the dust development in the case of hydraulically setting materials via the degree of milling or the particle composition of the pulverulent products, but the processability of coarser powders is substantially poorer.

A further known method is the aggregation of the finely divided particles, for example with the aid of water, aqueous solutions or dispersions. Thus, for example, U.S. Pat. No. 4,780,143 discloses the addition of aqueous foam to clinker prior to milling to give cement for reducing the dust development. Attempts were also made to add plastics dispersions to cements for air-placed concrete compositions in order thus to reduce the dust formation. However, such aggregation is disadvantageous when the hydraulically setting materials dedusted in this manner are subsequently no longer milled. In finely pulverulent filling compounds, relatively coarse aggregations are in fact unacceptable since they are clearly apparent on smooth surfaces.

Use of so-called dust-reducing agents which are added to the mixing water of cement in order to reduce dust formation on application of air-placed concrete or pneumatically applied mortar is also known. For this purpose, in particular polyethylene glycols or ethylene oxide/propylene oxide block copolymers are used as dust binders or additives for reducing dust formation. However, in many cases such additives have an adverse effect on the processing behaviour since they lead in particular to retardation of setting or pronounced hygroscopicity of the construction chemistry products. If hydrophobic additives, also including ethylene oxide/propylene oxide block copolymers, are used as an alternative, wetting difficulties result, especially in the case of pulverulent construction chemistry products.

WO 2006/084588 A1 discloses the use of aliphatic hydrocarbons and hydrocarbon mixtures as additives for reducing dust formation of dry and in particular pulverulent construction chemistry products, such as tile adhesives, joint fillers, filling compounds, sealing slurries, etc. In particular, hydrocarbons which are liquid under normal conditions are described, aliphatic hydrocarbons, especially in linear or branched, saturated or unsaturated form, having boiling points of 100 to 400° C., being mentioned in particular.

The utility model DE 20 2006 016 797 U1 relates to a low-dust dry mortar which contains at least one dust-reducing component in an amount of 0.01 to 10% by weight, based on the total dry mixture. Here, the dust-reducing component is selected from the series consisting of the monoalcohols, such as, for example, 3-methoxybutanol, benzyl alcohol, 1,2-propanediol, hexanol, diacetone alcohol, ethyl diglycol, isopropanol, 2-ethylhexanol and/or alkanediols, such as 2-methylpentane-2,4-diol, neopentyl glycol and n-butane-2,5-diol. According to this publication, glycols, polyethylene glycols, fatty alcohols and polyphenyl alcohols are furthermore suitable. Furthermore, aliphatic ethers, cellulose ethers, alkoxylates and methyl/ethyl fatty acid ethers are mentioned.

With the known measures according to the prior art, the fundamental problem of the dust formation of the pulverulent building material compositions still could not be satisfactorily solved, especially from economic points of view. In particular, it is to be regarded as disadvantageous that it has been necessary to date to use relatively large amounts of the dedusting agent. This constitutes not only a cost factor but can also lead to a considerable pollution of the room air with volatile organic compounds during the use of the building material compositions.

It was therefore the object of the present invention to provide a process for the preparation of pulverulent building material compositions which manages with the use of less dedusting agents compared with the prior art. The dedusting effect should, however, be at least at the level of the processes used to date. The additives used for this purpose should be distinguished by simple applicability in combination with high efficiency. Moreover, they should not tend to agglomeration during use and also should not adversely affect the required property profile of the products.

This object was achieved by the provision of a process for dedusting a pulverulent building material composition, at least one dedusting agent which is liquid at 20° C. being brought into contact at a temperature of >40° C. with the pulverulent building material composition. This is preferably effected by spraying on.

Apart from the fact that the object could be completely achieved with respect to all specifications, it has surprisingly been found that the increased temperature leads to a significantly improved processability of the dedusting agents used.

Particularly suitable in the context of the present invention are dedusting agents containing alcohols, such as 3-methoxybutanol, benzyl alcohol, 1,2-propanediol, hexanol, diacetone alcohol, ethyldiglycol, isopropanol, 2-ethylhexanol, 2-methylpentane-2,4-diol, neopentylglycol, 2-methylpentane-2,4-diol, neopentylglycol, n-butane-1,3-diol, n-butane-1,5-diol, n-butane-2,5-diol and/or glycols and/or polyethylene glycols and/or fatty alcohols. Furthermore, aliphatic ethers, in particular dialkyl ethers and/or cellulose ethers and/or alkoxylates and/or methyl/ethyl fatty acid ethers, tertiary aliphatically saturated monocarboxylic acids having 5-20 carbon atoms, unsaturated monocarboxylic acids having 5 to 20 carbon atoms, fatty acids and salts thereof, fatty acid esters, N-alkyl-N-alkanolamines, propylene carbonate, acetates, such as isopropyl acetate, hexyl acetate or ethylglycol acetate, aliphatic phosphoric acid esters, cyclohexanone, methyl isobutyl ketones, methyl heptyl ketones, perfluoropolymethyl isopropyl ether, silicone oils, polysiloxane-polyether copolymers, hydrocarbons, in particular linear or branched, preferably linear, saturated or unsaturated, preferably saturated hydrocarbons and mixtures thereof can be used. Furthermore, it is of course also possible to use mixtures of said dedusting agents.

The temperature of the dedusting agent used in the process according to the invention can be varied within wide ranges. The dedusting agent used preferably has a temperature between 41 and 150° C., particularly preferably 45 to 80° C. and in particular 50 to 65° C. It may also be expedient here to heat the total pulverulent building material composition before application of the dedusting agent. The temperature range preferred here for the pulverulent building material composition is between 41 and 150° C., particularly preferably 45 to 80° C. and in particular 50 to 65° C. In a preferred embodiment, the pulverulent building material composition is heated to a temperature which is similar to that of the dedusting agent used, a temperature difference of <±5° C. being particularly preferred.

It has proved to be essential to the invention that each of the dedusting agents used is in liquid form at 20° C. The advantage is that liquid application forms can be more readily applied to the pulverulent building material composition to be dedusted and that the application takes place as a whole homogeneously in comparison with solid variants. Hereby, in the case of the liquid compositions according to the invention, significantly smaller amounts are required. Of course, the adhesion and the initial adhesion of the additives which are liquid at 20° C. are also improved in comparison with the dedusting agents which are solid at this temperature. In this connection, the inventive compounds preferably have a kinematic viscosity of 0.1 to 30 mm²/s, in particular 5 to 20 mm²/s, at 20° C.

In general, the abovementioned treatment or bringing into contact is effected by spraying the respective chosen dedusting or dust-reducing additives onto the pulverulent building material compositions. In this way, the homogeneous application can be ensured in a simple manner with simultaneous good adhesion and initial adhesion. Of course, bringing the pulverulent building material compositions into contact with the respective additive can also be effected in any other suitable manner, known to a person skilled in the art. Mixing or stirring in the liquid additives is also particularly suitable here, but spray application is clearly preferable since this represents the simplest and economically most attractive application variant.

In the context of the present invention, the pulverulent building material compositions containing at least one dedusting agent should preferably be present in dry form, where this is to be understood as meaning that they have a water content according to Karl Fischer of less than 5% by weight, preferably less than 1% by weight and particularly preferably less than 0.1% by weight.

The average particle size in the respective pulverulent building material compositions should preferably range from 0.01 to 5 mm. It has proved to be particularly advantageous if the pulverulent building material compositions have a particle size fraction, determined by laser diffractometry, of at least 2% by weight≦68 μm and at least 10% by weight≦200 μm. Particularly in the case of the very finely divided variants, the dedusting potential of the process according to the invention is particularly clearly displayed.

In principle, any desired pulverulent building material compositions can be significantly dedusted with the additives used according to the invention. In particular, hydraulically setting cement-based and non-hydraulically-setting gypsum-based materials, so-called factory dry mortars, in which finely milled mineral substances harden in a stone-like manner with water absorption in air or under water and are capable of functioning after their hardening, should be mentioned as being typical of the building material compositions. Such factory dry mortars are generally commercially available as fine powders which are then made up with the mixing water in the final mixing at the building site. Transferring between or emptying of transport containers then results in disadvantageous pronounced dust development which can be substantially reduced or completely suppressed by the use of the dialkyl ethers now proposed.

The use according to the invention has proved to be particularly advantageous when the factory dry mortar comprises tile adhesives, joint fillers, filling compounds, sealing slurries, repair mortars, levelling mortars, reinforcing adhesives, adhesives for composite thermal insulation systems (CTIS), mineral renders, fine fillers and screed systems.

Also suitable for the process according to the invention are pulverulent polymers and in particular redispersible polymer powders or tile adhesives which are the pulverulent building material compositions or which are present as the pulverulent constituents thereof. Said redispersible polymer powders are preferably composed of at least one member of the series consisting of vinyl acetate, styrene, butadiene, ethylene, vinyl versatate, urea-formaldehyde condensates and melamine-formaldehyde condensates.

In order also actually to achieve the dedusting or the dust reduction to the desired advantageous extent, it is advisable to add the dedusting agents to the preferably dry, pulverulent building material compositions in an amount of 0.01 to 6% by weight, preferably of 0.2 to 4% by weight and particularly preferably of 0.3 to 2.0% by weight.

Of course, the pulverulent building material compositions which are to be dedusted in each case and to which the additives are added according to the invention may additionally contain at least one member of the series consisting of binders, fillers, thickeners, water retention agents, dispersants, rheology improvers, antifoams, retardants, accelerators, additives, pigments, organic or inorganic fibres, in addition to said finely divided particles.

In principle, it is advisable for the pulverulent building material compositions which are to be dedusted in the context of the present invention to have a proportion of binder in the range from 5 to 80% by weight, preferably from 10 to 70% by weight and particularly preferably from 15 to 50% by weight.

The dedusting agents used according to the invention are preferably stable to oxidation and undergo no chemical reactions, particularly under atmospheric oxygen, so that their dedusting properties with regard to the pulverulent building material compositions are also maintained at least substantially unchanged over a long storage period.

According to the invention, it is preferable if the dedusting agents according to the invention have an evaporative loss at a temperature of 107° C. over 24 hours of less than 5% by weight, preferably of less than 2% by weight, particularly preferably of less than 1% by weight, based on the dedusting means used. In this way, it is ensured that firstly long-term dedusting with regard to the pulverulent building material compositions treated according to the invention is achieved and secondly the products treated according to the invention are at least substantially odourless or have little odour since the dedusting agents are not released in significant amounts.

The dedusting agents employed in the context of the use according to the invention can of course also be supported in their dust-reducing or dedusting effect by all other suitable additives. Even if the proposed dedusting agents are completely sufficient for reducing or completely suppressing the dusting behaviour of pulverulent building material compositions in the predominant applications, it may be entirely expedient in special cases to support the advantageous effect of these additives by other admixtures which in turn likewise have a reducing effect on the dusting behaviour.

In general, the proposed process provides pulverulent building material compositions which have a greatly reduced or completely suppressed tendency to dust formation when very little dedusting agent is used, so that, even from the points of view of work safety, particularly during the transfer and processing process, excellent efficiency is observable. In particular, the reduced used of dedusting agent can also contribute to reduced pollution of the room air and of the environment by volatile organic compounds.

The following examples illustrate the advantages of the present invention.

### EXAMPLES

### Method of Measurement

The measurements were carried out on the basis of DIN 55999-2 “Determination of a scale for the dust development of pigments and fillers—Part 2: Case study method”. The “dust measuring apparatus SP3” of LORENZ MESSGERÄTEBAU GmbH & Co. KG was used for the measurement.

### Sample Preparation

The respective dry mortar mixture was initially introduced into a mixing vessel. The dedusting additive was heated to 50° C. and applied in the stated ratio to the dry mortar mix by means of a pressure sprayer (“flower spray”) and mixed with the mortar.

### Example 1

### Joint Mortar 1

| | |
|---|---|
| Portland cement CEM I | 36.5% by weight |
| Quartz sand 0.1-0.2 mm | 51.8% by weight |
| Limestone powder <0.1 mm | 8.0% by weight |
| Cellulose ether | 2.2% by weight |
| Dispersion powder (Vinnapas 7031 H ® | 1.0% by weight |
| from Wacker Chemie AG) | |
| Hardening accelerator (calcium formate) | 0.5% by weight |

| | Dust index | Dust index |
|---|---|---|
| | after 0 days | after 28 days |
| Joint mortar 1 (comparison) | 150 | 200 |
| Joint mortar 1 + 3% of Pluriol ® | 10 | 30 |
| E 400 (comparison) | | |
| Joint mortar 1 + 2% of Pluriol ® | 30 | 50 |
| E 400 (comparison) | | |
| Joint mortar 1 + 2% of Pluriol ® | 10 | 30 |
| E 400 (50° C.) | | |

Pluriol ® E 400 from BASF SE: polyethylene glycols of the general formula HO(CH₂CH₂O)ₙH, having an average molar mass of 400.
In comparison with the metering of the dedusting agent at room temperature (20° C.), a smaller demand of about 30% results through the metering at 50° C., the dedusting effect being the same.

### Example 2

### Tile Mortar 1

| | |
|---|---|
| Portland cement CEM I | 60.5% by weight |
| Quartz sand 0.1-0.5 mm | 23.6% by weight |
| Limestone powder <0.1 mm | 10.5% by weight |
| Cellulose ether | 1.9% by weight |
| Dispersion powder (Elotex AP 200 ® from | 3.0% by weight |
| Elotex AG) | |
| Hardening accelerator (calcium formate) | 0.5% by weight |

| | Dust index | Dust index |
|---|---|---|
| | after 0 days | after 28 days |
| Tile mortar 1 (comparison) | 150 | 250 |
| Tile mortar 1 + 2% of Pluriol ® | 30 | 50 |
| E 400 (comparison) | | |
| Tile mortar 1 + 2% of Pluriol ® | 10 | 30 |
| E 400 (50° C.) | | |

In comparison with the metering of the dedusting agent at room temperature (20° C.), a substantially improved dedusting effect results through the metering at 50° C., the amount used being the same.

1. Process for dedusting a pulverulent building material composition, wherein at least one dedusting agent which is liquid at 20° C. is brought into contact at a temperature of greater than 40° C. with the pulverulent building material composition.

2. Process according to claim 1, wherein alcohols, and/or glycols and/or polyethylene glycols and/or fatty alcohols are used as dedusting agents.

3. Process according to claim 1, wherein aliphatic ethers and/or cellulose ethers and/or alkoxylates and/or methyl/ethyl fatty acid ethers are used as dedusting agents.

4. Process according to claim 1, wherein tertiary aliphatically saturated monocarboxylic acids having 5-20 carbon atoms, unsaturated monocarboxylic acids having 5 to 20 carbon atoms, fatty acids or salts thereof or mixtures thereof are used as dedusting agents.

5. Process according to claim 1, wherein fatty acid esters, N-alkyl-N-alkanolamines, propylene carbonate, acetates, aliphatic phosphoric acid esters or mixtures thereof are used as dedusting agents.

6. Process according to claim 1, wherein cyclohexanone, methyl isobutyl ketones, methyl heptyl ketones or mixtures thereof are used as dedusting agents.

7. Process according to claim 1, wherein perfluoropolymethyl isopropyl ether is used as the dedusting agent.

8. Process according to claim 1, wherein silicone oils, polysiloxane-polyether copolymers or mixtures thereof are used as dedusting agents.

9. Process according to claim 1, wherein hydrocarbons are used as dedusting agents.

10. Process according to claim 1, wherein the pulverulent building material composition has a particle size fraction, determined by laser diffractometry, of at least 2% by weight less than or equal to 68 μm and at least 10% by weight less than or equal to 200 μm.

11. Process according to claim 1, wherein the building material composition contains pulverulent polymers.

12. Process according to claim 1, wherein the building material composition has a proportion of 0.01 to 6% by weight of dedusting agent.

13. Process according to claim 1, wherein the building material composition has a water content according to Karl Fischer of less than 5% by weight.

14. Process according to claim 1, wherein the building material composition additionally contains at least one of binders, fillers, thickeners, water retention agents, dispersants, additives, pigments, organic fibres or inorganic fibres.

15. Process according to claim 1, wherein the building material composition has a proportion in the range from 5 to 80% by weight of hydraulic binder.

16. Process according to claim 2, wherein the alcohol is at least one of 3-methoxybutanol, benzyl alcohol, 1,2-propanediol, hexanol, diacetone alcohol, ethyldiglycol, isopropanol, 2-ethylhexanol, 2-methylpentane-2,4-diol, neopentylglycol, 2-methylpentane-2,4-diol, neopentylglycol, n-butane-1,3-diol, n-butane-1,5-diol, or n-butane-2,5-diol.

17. Process according to claim 5, wherein the acetate is at least one of isopropyl acetate, hexyl acetate or ethylglycol acetate.

18. Process according to claim 11, wherein the building material composition contains redispersible polymer powders.
